(19) United States
(12) Patent Application Publication
(10) Pub. No.: US 2004/0026943 A1
(43) Pub. Date: Feb. 12, 2004

(54) Tool for gripping a heavy hollow object, for its displacement

(76) Inventor: Jean Hauville, Montillot (FR)

Correspondence Address: YOUNG & THOMPSON, 745 SOUTH 23RD STREET 2ND FLOOR, ARLINGTON, VA, 22202

(21) Appl. No.: 10/344,936

(22) PCT Filed: Aug. 16, 2001
(86) PCT No.: PCT/FR01/02618

(30) Foreign Application Priority Data
Aug. 16, 2000 (FR) 00/10650

(51) Int. Cl. B65G 7/12

(52) U.S. Cl. 294/103.1; 294/17

(57) ABSTRACT

The invention concerns a tool for gripping and clamping the edge (R) of a heavy hollow object such as a flower pot for example. The invention is characterized in that it comprises an elongated supporting arm (1) whereof one end part (1c) is curved downwards in the form of a hook and constitutes a first jaw of the clamp and an element (2) mounted sliding on the supporting arm (1) extending downwards, constituting a second jaw of the clamp such that in clamping position, the end of the first clamp jaw (1c) and the lower end part of the second clamp jaw (2f) are respectively in contact with the substantially opposite points (A, B), located respectively on the inner and outer surfaces of the edge (R) of the object.

The present invention relates to a tool for gripping and clamping the edge of a heavy hollow object, such as a recipient, with a view to lifting and displacing it.

It is often necessary to displace recipients resting on the ground and containing a relatively heavy solid matter. Such is the case in particular of flower pots of large dimensions which have to be transported into a shelter, before the beginning of the winter, and then placed outside again as soon as the outside temperature is sufficiently high. Manipulation of these large-dimensioned flower pots is tiring and awkward due to their considerable weight, to the absence of handles and to the peripheral space requirement of the plants. Generally, such manipulation involves manual lifting by a difficult and tiring grip of the edge of a pot thereafter transported by foot or with the aid of a wheelbarrow.

It is an object of the present invention to overcome these drawbacks by providing a tool of particularly simple design making it possible to grip the edge of a recipient such as a flower pot and to systematically clamp this edge during the natural movement of lift of the recipient.

To that end, this tool for gripping and clamping the edge of a heavy hollow object, such as a recipient, with a view to lifting and displacing it, is noteworthy in that it comprises an elongated supporting arm of which an end part is curved downwards in the form of a hook and constitutes a first jaw of the clamp and an element mounted to slide on the supporting arm extending downwards, opposite the hook-shaped part of the first jaw, constituting a second jaw of the clamp so that, in clamping position, the end of the first clamp jaw and the lower end part of the second clamp jaw are respectively in contact with substantially opposite points, located respectively on the inner and outer surfaces of the edge of the object.

Various forms of embodiment of the present invention will be described hereinafter by way of non-limiting examples, with reference to the drawings, in which:

FIG. 1 is a view in vertical section of a tool according to the invention for gripping and clamping the edge of a recipient, in position of grip.

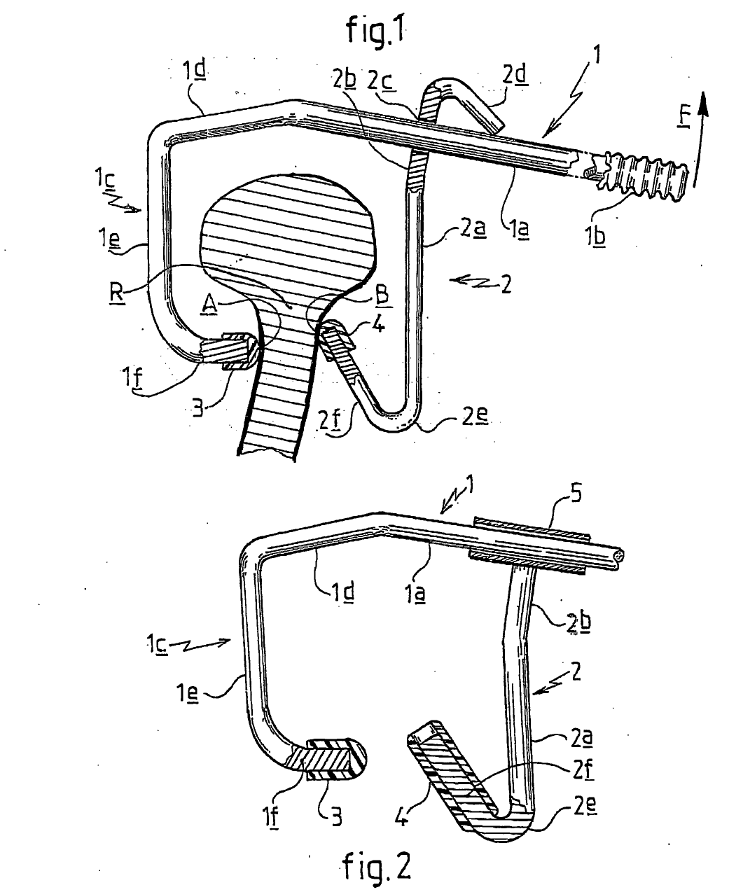

FIG. 2 is a partial view in vertical section of a variant embodiment of the gripping and clamping tool.

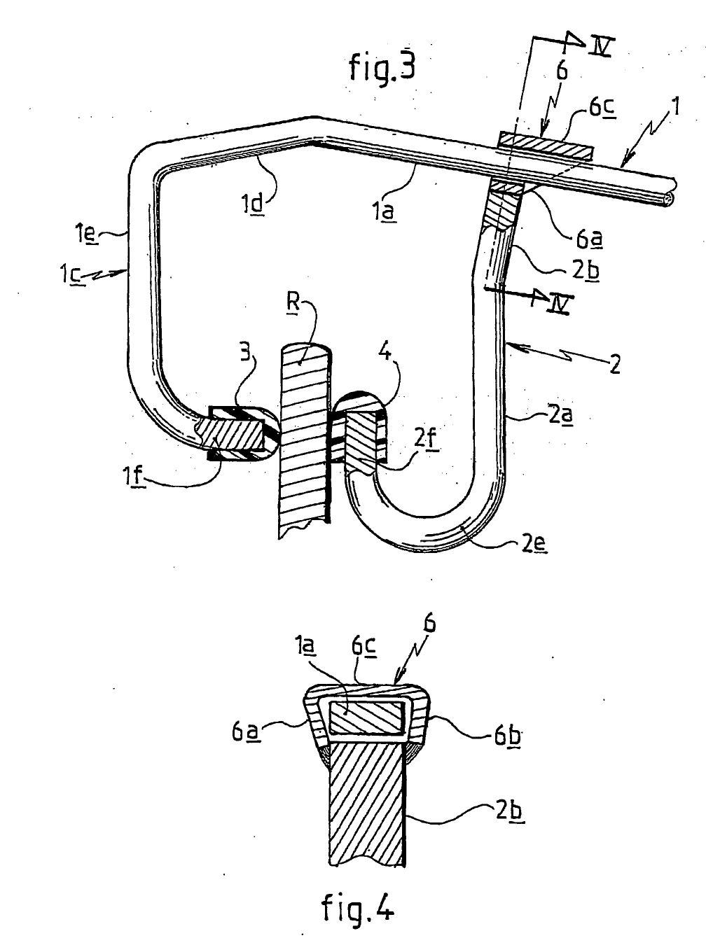

FIG. 3 is a partial view in vertical section of another variant embodiment of the gripping and clamping tool.

FIG. 4 is a view in section along line IV-IV of FIG. 3.

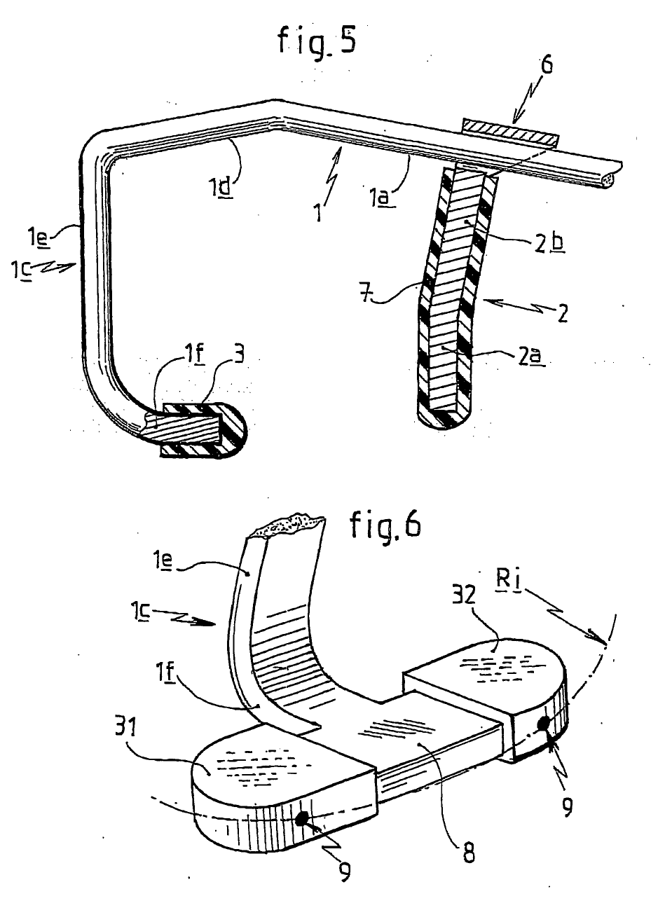

FIG. 5 is a partial view in vertical section of another variant embodiment of the gripping and clamping tool.

FIG. 6 is a partial representation on a larger scale of a final variant embodiment of the gripping and clamping tool.

FIG. 1 shows a gripping and clamping tool according to the invention in engagement with the edge R of a recipient such as a flower pot, presenting a swell at its upper end. The tool comprises two elements of which the end parts constituting the two jaws of a clamp, namely a supporting arm 1 and a bearing element (counter-plate) 2 mounted to slide on the supporting arm 1. This supporting arm 1 may be constituted by a solid bar of rectangular cross-section or by a sectioned profile of any cross-section. The supporting arm 1 comprises a rectilinear principal portion 1a, of great length, bearing a handle 1b at its end, and connected to an end part 1c in the form of a downwardly curved hook, this end part 1c constituting a first clamp jaw. This end part 1c comprises more particularly a downwardly inclined intermediate upper portion 1d, connected to the principal portion 1a and forming therewith an obtuse angle, a vertical portion 1e and a horizontal lower portion 1f.

The bearing element 2 comprises a substantially vertical principal portion 2a which is extended, at its upper end, by an upper portion 2b pierced with an opening 2c through which the principal portion 1a of the supporting arm 1 passes. The upper portion 2b is inclined, with respect to the vertical portion 2a, so as to be perpendicular the principal portion 1a of the supporting arm 1, in order to allow the bearing element 2 to slide on the supporting arm 1. The upper portion 1b is connected to an end portion 2d which is curved downwards and in the direction of the handle 1b of the supporting arm 1, so that the end of the end portion 2d is in contact with the upper surface of the principal portion 1a of the supporting arm 1. At its lower end, the vertical portion 2a of the bearing element 2 is connected, by a bend 2e, to an end portion 2f which is inclined upwards, constituting a V-shaped hook extending towards the hook-shaped end part 1c of the supporting arm 1. The hook 2e, 2f of the bearing element 2 constitutes the second clamp jaw of the tool.

The ends of the end portion 1f of the hook-shaped part 1c and of the end portion 2f of the bearing element 2 are advantageously covered with respective endpieces 3, 4 made of plastics material which are intended to come respectively into contact with the inner and outer surfaces of the edge R of the recipient.

The opening 2c of the bearing element 2 through which the principal portion 1a of the supporting arm 1 passes, has dimensions which are slightly greater than those of the transverse section of the portion 1a in order to facilitate slide of the bearing element 2 on the supporting arm 1.

In order to lift and displace the recipient, the tool according to the invention is placed in the position of grip shown in FIG. 1. In that case, the endpiece 3 provided at the end of the hook-shaped curved part 1c is in contact with a point A on the inner surface of the recipient and the endpiece 4 provided at the end of the end portion 2f of the bearing element 2 is in contact with a point B of the outer surface of the recipient, this point B being close to point A and located at a slightly higher level. Consequently, when a lifting effort is exerted on the handle 1b of the supporting arm 1, which effort is indicated by arrow F in FIG. 1, the rotation of the supporting arm 1 about the point of contact A tends to drive point B in rotation about point A, which is translated by an effect of clamping between points A and B, the hook-shaped end part 1c and the bearing element 1 in that case playing the role of the two jaws of a clamp. The edge R of the recipient is thus clamped between the two endpieces 3 and 4 and the recipient may then be lifted and transported easily.

In the variant embodiment shown in FIG. 2, the upper portion 2b of the bearing element 2 is welded to a sleeve 5 sliding on the principal portion 1a of the supporting arm 1. This sleeve has an inner transverse section slightly greater than that of the transverse section of the principal portion 1a in order to facilitate slide.

In the variant embodiment shown in FIGS. 3 and 4, the upper portion 2b of the bearing element 2 is welded to a U-bracket 6 sliding on the principal portion 1a of the supporting arm 1. This bracket 6 presents a cross-section substantially in the shape of an upturned U, and the lower ends of the two wings 6a, 6b of the bracket 6 which are bent downwards, are welded to the two lateral faces of the upper portion 2b of the bearing element 1. The upper web 6c of the bracket 6 extends in the direction of the handle 1b of the principal portion 1a of the supporting arm 1 over a distance greater than the thickness of the bearing element 2. Furthermore, in the tool shown in FIG. 3, the bend 2e extends over an angle of 180°, so that the lower end portion 2f and consequently the endpiece 4 that it bears extend vertically upwards, thus constituting a V-shaped hook. This arrangement makes it possible to ensure an efficient clamping of an edge of a recipient R not having a swell at its end.

In the variant embodiment shown in FIG. 5, the bearing element 2 has no hook 2e, 2f and the lower end part of its principal portion 2a extends vertically, opposite the horizontal lower portion 1f of the hook 1c and at the level thereof. Furthermore, the bearing element 2 is totally covered with a coating 7 made of plastics material.

According to a final variant embodiment, shown partially in FIG. 6 and applicable to all the preceding variants, the end 1f of the hook 1c is provided with a stabilizer stop 8 fast with and disposed perpendicularly to the plane formed by the portions 1e and 1f of the first jaw of the clamp, advantageously symmetrically on either side of the hook 1c, increasing, in its position of clamping, the bearing of the tool on the inner face Ri of the recipient R. The two ends at least of the stop 8 which is horizontal come, in effect, into abutment 9 on the inner face Ri, which promotes the vertical grip of the recipient by better mastering its tipping. Accessorily, it is preferable to add around the ends of the stop 8, protecting endpieces 31, 32 made of a plastics material for example.

It goes without saying that the stop 8 might be connected to the end of the hook 1c on one side, to the left or to the right of the horizontal portion 1f which, according to another variant, might be bent to 90° in order to perform the same function.

The gripping and clamping tool according to the invention which has been described hereinabove may be used alone or with another similar tool to ensure simultaneous clamping at two diametrally opposite points of the recipient.

1. Tool for gripping and clamping the edge (R) of a heavy hollow object, such as a recipient, with a view to lifting and displacing it, characterized in that it comprises an elongated supporting arm (1) of which an end part (1c) is curved downwards in the form of a hook and constitutes a first jaw of the clamp and an element (2) mounted to slide on the supporting arm (1) extending downwards, opposite the hook-shaped part (1c) of the first jaw, constituting a second jaw of the clamp so that, in clamping position, the end of the first clamp jaw (1c) and the lower end part of the second clamp jaw (2f) are respectively in contact with substantially opposite points (A, B), located respectively on the inner and outer surfaces of the edge (R) of the object.

2. Tool according to claim 1, characterized in that the sliding element (2) is a bearing element (counter-plate) comprising a principal portion (2a) extending substantially vertically in position of clamping, and extended upwards by an upper portion (2b) sliding on an elongated principal portion (1a) of the supporting arm (1).

3. Tool according to claim 2, characterized in that the principal portion (2a) of the bearing element (2) is extended, at its lower end, by a hook (2e, 2f) curved upwards, towards the hook (1c) of the first jaw, and in the form of a U or V.

4. Tool according to either one of claims 2 or 3, characterized in that the upper portion (2b) of the bearing element (2) is pierced with a hole (2c) traversed by the principal portion (1a) of the supporting arm (1) and the upper portion (2b) is extended by an end portion (2d) curved in the direction of the principal portion (1a) of the supporting arm (1) so that its end is in contact with the upper surface of this arm.

5. Tool according to either one of claims 2 or 3, characterized in that the upper portion (2b) of the bearing element (2) is welded to a sleeve (5) sliding on the principal portion (1a) of the supporting arm (1).

6. Tool according to either one of claims 2 or 3, characterized in that the upper portion (2b) of the bearing element (2) is welded, at its upper end, to a bracket (6) covering the principal portion (1a) of the supporting arm (1) and sliding thereon.

7. Tool according to any one of claims 2 to 6, characterized in that in the position of clamping in which the principal portion (1a) of the supporting arm (1) is inclined downwards, outside the recipient and thereabove, the hooked-shaped end part (1c) comprises, from top to bottom, an upper intermediate portion (1d) inclined downwards and forming an obtuse angle with the principal portion (1a), a substantially vertical portion (1e) and a lower end portion (1f) curved substantially horizontally and in contact, at its end, with a point (A) of the inner surface of the recipient.

8. Tool according to claim 7, characterized in that the upper portion (2b) of the bearing element (2) is inclined, forming an obtuse angle, with respect to the principal portion (2a) so that this latter portion extends substantially vertically.

9. Tool according to any one of the preceding claims, characterized in that the end part (1f) of the hook (1c) of the first jaw comes, in the position of clamping, into abutment on the inner face Ri of the edge of the object R to be displaced, via a stabilization stop (8) which is fast therewith and disposed perpendicularly to the plane formed by the portions (1e) and (1f) of said jaw, advantageously symmetrically on either side of the hook (1c).

10. Tool according to any one of the preceding claims, characterized in that endpieces (3, 4, 7, 31, 32) made of plastics material are respectively applied on the end part of the hook (1c) of the first jaw and at least on the end part of the second jaw.

11. Tool according to any one of claims 1 to 10, characterized in that the supporting arm (1) comprises a handle (1b) at its end.
